(19) United States
(12) Patent Application Publication
(10) Pub. No.: US 2016/0029836 A1
(43) Pub. Date: Feb. 4, 2016

(54) RECIPE INFORMATION PROCESSING APPARATUS, COOKING APPARATUS, AND RECIPE INFORMATION PROCESSING METHOD

(71) Applicant: Panasonic Intellectual Property Management Co., Ltd., Osaka (JP)

(72) Inventors: ICHIRO TAKEI, Tokyo (JP); HIROYUKI KAYAMA, Osaka (JP)

(21) Appl. No.: 14/801,512

(22) Filed: Jul. 16, 2015

(30) Foreign Application Priority Data
Aug. 4, 2014 (JP) 2014-158574

(51) Int. Cl. A47J 36/00; A23L 1/01

(52) U.S. Cl. CPC A47J 36/00; A23L 1/01

(57) ABSTRACT

A cooking apparatus includes a recipe obtaining unit that obtains recipe information for a dish, a modification obtaining unit that obtains first modification information used to modify the obtained recipe information, and a taste complement unit that generates taste complement recipe information based on the obtained recipe information, the first modification information, and second modification information. The second modification information makes a complement to degradation of taste satisfaction with a dish offered based on the obtained recipe information modified by using the first modification information.

### BACKGROUND

1. Technical Field

The present disclosure relates to a recipe information processing apparatus, a cooking apparatus, and a recipe information processing method that process recipe information for a dish.

2. Description of the Related Art

In recent years, information obtained through conversion of recipe for a dish into electronic data (hereinafter such information will be referred to as “recipe information”) has been widely utilized. For example, Patent Literature (PTL) 1 describes a cooking apparatus that receives selection from recipe information previously prepared for each dish type and performs stirring of ingredients, adjustment of cooking time, temperature, and pressure in response to the selected recipe information. Using such a conventional technique allows simple preparation of a dish.

### CITATION LIST

### Patent Literatures

PTL 1: Unexamined Japanese Patent Publication No. 2007-282700

PTL 2: Unexamined Japanese Patent Publication No. H03-163351

However, when an amount of ingredient used for a dish is restricted (hereinafter referred to as “dietary restrictions”), such as salt restrictions and carbohydrate restrictions for purposes of health care, medical treatment and the like, the prepared recipe information cannot be used as it is in some cases. In such a case, a user needs to modify the recipe information, such as reducing the amount of salt. Then, such modification may change taste of the dish and degrade satisfaction of the user with the taste of the dish (hereinafter referred to as “taste satisfaction”).

### SUMMARY

One non-limiting and exemplary embodiment provides taste satisfaction with minimum degradation accompanying modification of recipe information.

In one general aspect, the techniques disclosed here feature a recipe information processing apparatus including: a recipe obtaining unit that obtains recipe information for a dish; a modification obtaining unit that obtains first modification information used to modify the obtained recipe information; a taste complement unit that generates taste complement recipe information based on the obtained recipe information, the first modification information, and second modification information, the second modification information making a complement to degradation of taste satisfaction with a dish offered based on the obtained recipe information modified by using the first modification information.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

It should be noted that general or specific embodiments may be implemented as a system, a method, an integrated circuit, a computer program, a computer-readable storage medium, or any selective combination thereof. The computer-readable storage medium includes a nonvolatile storage medium, such as a CD-ROM (Compact Disc-Read Only Memory), for example.

The present disclosure makes it possible to minimize degradation of taste satisfaction accompanying modification of recipe information.

### BRIEF DESCRIPTION OF THE DRAWINGS

FIG. 1 is a block diagram illustrating an example of a configuration of a cooking apparatus according to a first exemplary embodiment of the present disclosure;

FIG. 2 is a diagram illustrating an example of an ingredient taste table according to the present first exemplary embodiment;

FIG. 3 is a diagram illustrating an example of a taste complement table according to the present first exemplary embodiment;

FIG. 4 is a diagram illustrating a first example of taste complement strength information according to the present first exemplary embodiment;

FIG. 5 is a diagram illustrating a second example of taste complement strength information according to the present first exemplary embodiment;

FIG. 6 is a flow chart illustrating an example of an operation of the cooking apparatus according to the present first exemplary embodiment;

FIG. 7 is a block diagram illustrating an example of the configuration of the cooking apparatus according to a second exemplary embodiment of the present disclosure;

FIG. 8 is a diagram illustrating an example of a taste change table according to the present second exemplary embodiment;

FIG. 9 is a diagram illustrating an example of taste change information according to the present second exemplary embodiment; and

FIG. 10 is a flow chart illustrating an example of the operation of the cooking apparatus according to the present second exemplary embodiment.

### DETAILED DESCRIPTION

### First Exemplary Embodiment

One exemplary embodiment of the present disclosure will be described in detail below with reference to the drawings. A cooking apparatus according to the present exemplary embodiment is, for example, a microwave oven, an IH (Induction Heating) cooking heater, or an apparatus in which these functions cooperate, including a user interface such as a touch-panel display.

It should be noted that in the following descriptions, a dish has a wide concept including a plurality of ingredients simply combined, and beverages. Making a complement to degradation of taste satisfaction with a dish is a concept including inhibition of degradation of taste satisfaction and enhancement of taste satisfaction.

A “taste vector” in the following description is a vector in predetermined taste space, and quantifies and expresses a taste and its strength. For example, a technique described in PTL 2 can quantify a taste and its strength. The taste space is space including a plurality of axes each corresponding to strength of a different basic taste. The basic tastes refer to, for example, basic taste types, and include five taste types: bitter, sweet, umami, salty, and sour. In this case, the predetermined taste space refers to, for example, five-dimensional space that combines five axes: a bitter taste axis, a sweet taste axis, an umami taste axis, a salty taste axis, and a sour taste axis.

### <Configuration of the Cooking Apparatus>

First, a configuration of the cooking apparatus according to the present exemplary embodiment will be described.

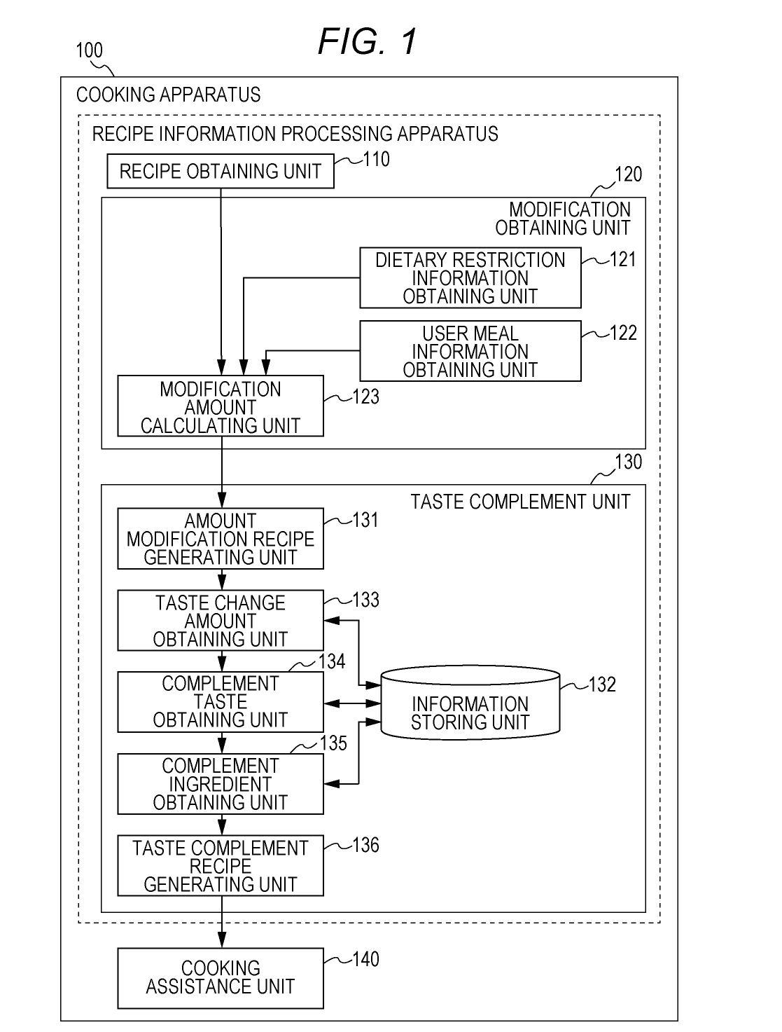

FIG. 1 is a block diagram illustrating an example of the configuration of the cooking apparatus according to the present exemplary embodiment.

In FIG. 1, cooking apparatus 100 includes recipe obtaining unit 110, modification obtaining unit 120, taste complement unit 130, and cooking assistance unit 140. It should be noted that recipe obtaining unit 110 to taste complement unit 130 correspond to a recipe information processing apparatus according to the present disclosure.

Recipe obtaining unit 110 obtains recipe information for a dish. More specifically, recipe obtaining unit 110 receives, for example, selection from a plurality of predetermined dish types from a user via a user interface. Recipe obtaining unit 110 then accesses a memory that previously stores recipe information for each dish type, and obtains recipe information for the selected dish type. Such a memory may be included in cooking apparatus 100, and may be included in a server (on a cloud) on a communication network. Recipe obtaining unit 110 then outputs the obtained recipe information to modification obtaining unit 120.

Here, the recipe information includes at least information that specifies a plurality of ingredients that constitute a dish and information that specifies an amount (weight, volume, quantity, or proportion) of each of the ingredients. The ingredients may also include seasonings such as salt and pepper, water, and food ingredients such as meat and vegetables. The recipe information further includes a recipe for a person displaying information with a text or a voice, such as names of the ingredients, description and order of cooking, heating temperature, and heating time, control data that controls an operation of cooking assistance unit 140, and information regarding nutrients such as salt and calories.

In addition, in the following description, a dish obtained by cooking in accordance with the recipe information obtained by recipe obtaining unit 110 is referred to as a “reference dish.”

Modification obtaining unit 120 obtains first modification information to be applied to the recipe information. The first modification information is, for example, modification information for fitting a dish to dietary restrictions placed on a person (hereinafter referred to as a “user”) who eats the prepared dish. Modification obtaining unit 120 includes dietary restriction information obtaining unit 121, user meal information obtaining unit 122, and modification amount calculating unit 123.

Dietary restriction information obtaining unit 121 obtains dietary restriction information that indicates information on dietary restrictions placed on the user. The dietary restriction information includes at least a period maximum amount that is an upper limit of an amount of a first ingredient (for example, salt) that the user may ingest during a predetermined period that serves as a unit (for example, one day) of dietary restrictions. Dietary restriction information obtaining unit 121 receives input of the dietary restriction information from the user, for example, via the user interface. Dietary restriction information obtaining unit 121 then outputs the obtained dietary restriction information to modification amount calculating unit 123.

User meal information obtaining unit 122 obtains user meal information that indicates a history of a meal eaten by the user. The user meal information includes at least an already ingested amount that is a total amount of the first ingredient that the user has already ingested during the predetermined period (for example, during that day) that has been a target of the dietary restrictions. User meal information obtaining unit 122 receives input of the user meal information from the user, for example, via the user interface. User meal information obtaining unit 122 then outputs the obtained user meal information to modification amount calculating unit 123.

It should be noted that user meal information obtaining unit 122 may, for example, store a dish prepared by cooking assistance that cooking apparatus 100 provides, and may obtain the user meal information from a history of the prepared dish.

Modification amount calculating unit 123 calculates a value obtained by subtracting the already ingested amount from the period maximum amount (hereinafter such a value will be referred to as an “ingestible amount”), based on the dietary restriction information that is input from dietary restriction information obtaining unit 121 and on the user meal information that is input from user meal information obtaining unit 122. The ingestible amount is, in other words, an upper limit of the amount of the first ingredient that may be used for a next dish to be prepared. Modification amount calculating unit 123 then outputs the recipe information and the calculated ingestible amount (information that indicates first modification information) to taste complement unit 130.

It should be noted that, when modification of the recipe information is not required, modification amount calculating unit 123 may output the recipe information as it is to cooking assistance unit 140.

Taste complement unit 130 generates taste complement recipe information by applying to the recipe information the first modification information and second modification information that makes a complement to degradation of taste satisfaction caused by application of the first modification information to the recipe information.

In the present exemplary embodiment, the first modification information shall be modification of the amount of the first ingredient (for example, salt), and the second modification information shall be modification of an amount of a second ingredient (for example, vinegar). Modification of the amount of the second ingredient produces change in strength of a second taste (for example, a sour taste) that makes a complement to degradation of taste satisfaction caused by change in strength of a first taste (for example, a salty taste) caused by modification of the amount of the first ingredient.

Taste complement unit 130 includes amount modification recipe generating unit 131, information storing unit 132, taste change amount obtaining unit 133, complement taste obtaining unit 134, complement ingredient obtaining unit 135, and taste complement recipe generating unit 136.

Amount modification recipe generating unit 131 makes a modification (the first modification information) to the recipe information that is input from modification amount calculating unit 123 so that the amount of first ingredient may be equal to or less than the ingestible amount that is input from modification amount calculating unit 123, and generates amount modification recipe information. Amount modification recipe generating unit 131 then outputs the recipe information and the generated amount modification recipe information to taste change amount obtaining unit 133.

Information storing unit 132 previously stores information required for processing performed by taste change amount obtaining unit 133, complement taste obtaining unit 134, and complement ingredient obtaining unit 135. More specifically, information storing unit 132 stores an ingredient taste table, a taste complement table, and taste complement strength information.

The ingredient taste table is a table that describes, for each of the plurality of ingredients including the first ingredient and the second ingredient, a relationship between change in the amount of ingredient and change in taste strength caused by change in the amount of ingredient.

The taste complement table is a table that describes a relationship between change in strength of the first taste and change in strength of the second taste that makes a complement to degradation of taste satisfaction caused by the change in strength of the first taste (hereinafter such degradation will suitably be referred to simply as “degradation of taste satisfaction”).

The taste complement strength information corresponds to a diagram illustrating a relationship between change in strength of the first taste and change in strength of the second taste that accompanies the change in the strength of the first taste.

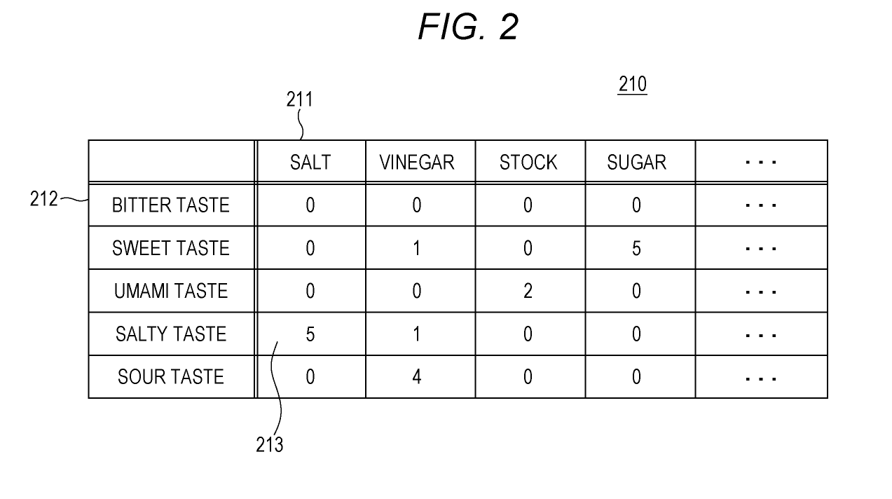

FIG. 2 is a diagram illustrating an example of the ingredient taste table.

As illustrated in FIG. 2, ingredient taste table 210 describes taste vector (hereinafter referred to as an “ingredient taste vector”) 213 having components each being taste strength of each basic taste 212 per unit amount of ingredient (unit weight, unit volume, or unit quantity, and 1 g in the following description) for each ingredient type 211.

Ingredient taste vector 213 is a taste vector that indicates a taste of the ingredient and its strength per unit amount of ingredient.

For example, ingredient taste table 210 describes ingredient taste vector 213 of “0, 0, 0, 5, 0” having components each being strength of each of “a bitter taste, a sweet taste, an umami taste, a salty taste, and a sour taste” in association with ingredient type 211 of “salt”. This indicates that salt has a salty taste with strength of “5” per 1 g.

In addition, ingredient taste table 210 describes ingredient taste vector 213 of “0, 1, 0, 1, 4” in association with ingredient type 211 of “vinegar”. This indicates that vinegar has a sweet taste with strength of “1” per 1 g, a sally taste with strength of “1”, and a sour taste with strength of “4.”

For example, an onion has a strong pungent taste in a raw state, and becomes sweet when heated. In this way, the taste vector in taste space can change before and after cooking depending on the ingredient. Therefore, the taste vector supposing after cooking may be used as the ingredient taste vector.

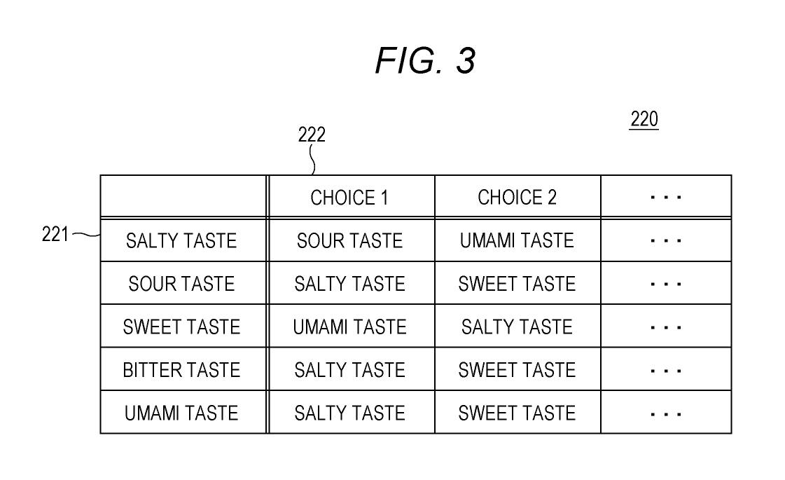

FIG. 3 is a diagram illustrating an example of the taste complement table.

As illustrated in FIG. 3, taste complement table 220 associates each basic taste 221 with choice 222 of other basic tastes that can be used for making a complement to taste change in a dish caused by change in each basic taste 221, and describes basic taste 221 and choice 222.

For example, the choices of “a sour taste” and “an umami taste” are described in association with basic taste 221 of “a salty taste”. This means that, when strength of a salty taste of a dish decreases, increase in strength of a sour taste or umami taste can make a complement to degradation of taste satisfaction caused by decrease in a salty taste.

It should be noted that principles of inhibition of degradation in taste satisfaction differ according to the types of first taste and second taste, and the types of dish and ingredient. Examples of such principles include a contrast effect of strong feeling of a salty taste caused by a sweet taste, a multiplier effect of strong feeling of a sweet taste caused by an umami taste, and an accompanying effect of many of ingredients having a strong sour taste being accompanied by a salty taste.

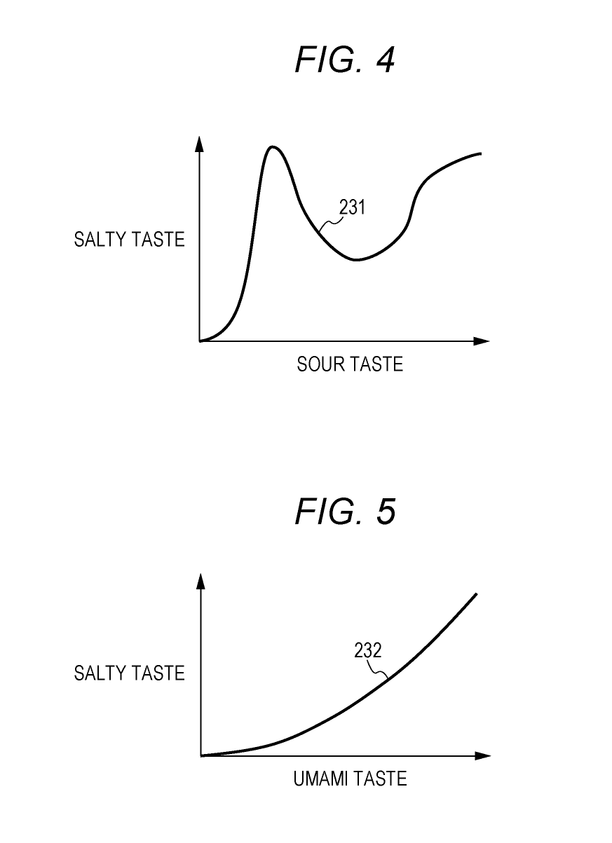

FIG. 4 and FIG. 5 are diagrams illustrating examples of the taste complement strength information. In FIG. 4 and FIG. 5, horizontal axes and vertical axes represent strength of change in a basic taste in a dish.

As illustrated in line 231 of FIG. 4, change in strength of a sour taste and change in strength of a salty taste have a relationship to make a mutual complement to degradation of taste satisfaction. As illustrated in line 232 of FIG. 5, change in strength of an umami taste and change in strength of a salty taste have a relationship to make a mutual complement to degradation of taste satisfaction.

The taste complement strength information differs, for example, according to a dish type and an ingredient type to be increased or decreased. For example, FIG. 4 shows taste complement strength information illustrating a correlation of change between a sour taste and a salty taste in a case of changing an amount of vinegar in a vinegared dish. FIG. 5 shows taste complement strength information illustrating a correlation of change between an umami taste and a salty taste in a case of changing an amount of stock in a vinegared dish.

When the taste complement strength information differs in this way according to the dish type and the ingredient type to be increased or decreased, information storing unit 132 may store the taste complement strength information for each combination pattern of the dish type and the ingredient type.

Reasons for degradation of taste satisfaction include various reasons such as overall weaker taste and change in taste balance, in addition to weaker main basic taste of a reduced food ingredient. The principles to inhibit degradation of taste satisfaction include various principles as described above. Accordingly, appropriate taste complement strength information is prepared and stored, for example, based on an experiment result or empirical rules.

With reference to ingredient taste table 210 (see FIG. 2), taste change amount obtaining unit 133 of FIG. 1 calculates, from the recipe information that is input from amount modification recipe generating unit 131, a taste vector of a dish (reference dish) in a case of cooking in accordance with the recipe information. In addition, with reference to ingredient taste table 210, taste change amount obtaining unit 133 calculates, from the amount modification recipe information that is input from amount modification recipe generating unit 131, a taste vector of a dish in a case of cooking in accordance with the amount modification recipe information (hereinafter such a dish will be referred to as an “amount modification dish”). The taste vector of each dish is calculated, for example, through addition of values obtained by multiplying an amount of each ingredient out of all the ingredients by the corresponding taste vector, and through division of the added values by a total amount of the dish.

Each component of the taste vector is an amount proportional to a value obtained through addition of a correction number unique to each basic taste to a logarithm of a concentration of the basic taste. Therefore, strictly speaking, calculation of a taste vector of an entire dish by such a linear vector operation causes slight deviation from an actual taste vector. However, since the logarithm of taste concentration is to be calculated, a small error does not cause any problem for human taste. Such first-order approximation of each component of the taste vector has an effect of simply calculating the taste vector of the entire dish.

Moreover, taste change amount obtaining unit 133 calculates a vector by subtracting the taste vector of the amount modification dish from the taste vector of the reference dish as a difference taste vector. The difference taste vector indicates change in strength of the first taste generated by modification of the amount of the first ingredient. That is, taste change amount obtaining unit 133 obtains an amount of change in strength of the first taste corresponding to modification of the amount of the first ingredient. Taste change amount obtaining unit 133 then outputs the amount modification recipe information and the calculated difference taste vector to complement taste obtaining unit 134.

With reference to taste complement table 220 and taste complement strength information (see FIG. 3 and FIG. 4), complement taste obtaining unit 134 determines change in strength of the second taste that makes a complement to degradation of taste satisfaction from the difference taste vector that is input from taste change amount obtaining unit 133. That is, complement taste obtaining unit 134 obtains change in strength of the second taste corresponding to change in strength of the obtained first taste.

More specifically, complement taste obtaining unit 134 determines the second taste that can make a complement to change in strength of the first taste indicated by the difference taste vector, based on taste complement table 220. Complement taste obtaining unit 134 then obtains degree of change in strength of the second taste corresponding to degree of change in strength of the first taste indicated by the difference taste vector, from the taste complement strength information. Complement taste obtaining unit 134 then outputs the amount modification recipe information and a complement taste vector that indicates degree of change in strength of the second taste to complement ingredient obtaining unit 135.

With reference to ingredient taste table 210 (see FIG. 2), complement ingredient obtaining unit 135 specifies an ingredient having a basic taste with highest taste strength identical to the complement taste vector that is input from complement taste obtaining unit 134, and determines the ingredient as an ingredient whose amount is to be increased (hereinafter referred to as a “complement ingredient”). At this time, complement ingredient obtaining unit 135 determines the complement ingredient from among a plurality of ingredients indicated by the amount modification recipe information that is input from complement taste obtaining unit 134. With reference to ingredient taste table 210, complement ingredient obtaining unit 135 determines an increase amount of the complement ingredient from the complement taste vector and the amount modification recipe information. That is, complement ingredient obtaining unit 135 obtains an amount of change in the amount of the second ingredient corresponding to the amount of change in strength of the obtained second taste.

More specifically, complement ingredient obtaining unit 135 calculates a value obtained by multiplying a largest component of the complement taste vector by an amount of the entire amount modification dish and by further dividing by a largest component of the ingredient taste vector of the determined ingredient, as the increase amount of the complement ingredient. Complement ingredient obtaining unit 135 then outputs the amount modification recipe information and complement ingredient information (information indicating the second modification information) indicating the complement ingredient and its increase amount to taste complement recipe generating unit 136.

It should be noted that, when the taste complement strength information differs from ingredient to ingredient as described above, taste change amount obtaining unit 133 and complement taste obtaining unit 134 may be integrally formed as a functional unit, and such a functional unit may determine the complement ingredient at one time.

Although increasing the complement ingredient has been described, when the recipe originally includes this ingredient, decreasing this ingredient may be able to make a complement to degradation of taste satisfaction. For example, decreasing a sour taste may make a salty taste conspicuous. Therefore, information corresponding to a case (on a minus side of the horizontal axis of FIG. 4 or FIG. 5) where a complement ingredient is decreased may also be stored as taste complement strength information.

Taste complement recipe generating unit 136 modifies the amount modification recipe information that is input from complement ingredient obtaining unit 135 into information (second modification information) that has the complement ingredient increased in accordance with the complement ingredient information that is input from complement ingredient obtaining unit 135. Taste complement recipe generating unit 136 then generates taste complement recipe information. That is, taste complement recipe generating unit 136 applies the obtained amount of change in the amount of the second ingredient to the amount modification recipe information, and generates the taste complement recipe information. Taste complement recipe generating unit 136 then outputs the generated taste complement recipe information to cooking assistance unit 140.

Cooking assistance unit 140 assists cooking in accordance with the taste complement recipe information that is input from taste complement recipe generating unit 136. More specifically, cooking assistance unit 140 includes, for example, a display device such as the above touch-panel display, and a heating device (not illustrated) to apply heat treatment. Cooking assistance unit 140 displays, on the above touch-panel display, a name and amount, and description and order of cooking of each ingredient included in taste complement recipe information, and performs heat cooking in accordance with heating temperature, heating time, and the like indicated by the taste complement recipe information. The heat cooking may be implemented through control of a magnetron, which is an example of a heater, with reference to a threshold value for an output value from a temperature sensor, an infrared sensor, a moisture sensor, and the like provided in a heat chamber, the threshold value being determined based on the taste complement recipe information. The heat cooking may be implemented through control of an IH coil for heating, which is an example of a heater, with reference to a threshold value for an output value from a temperature sensor, an infrared sensor, and the like provided in a plate, the threshold value being determined based on the taste complement recipe information.

It should be noted that cooking assistance unit 140 may use speech recognition or gesture recognition as the user interface, in addition to the touch panel. In addition, when part of functions of cooking apparatus 100 is on a cloud, cooking assistance unit 140 may not include a display device, and may use, for example, a display of a smart phone and a smart television that operate in cooperation with functions of cooking apparatus 100.

Although not illustrated, cooking apparatus 100 includes, for example, a CPU (Central Processing Unit), a storage medium such as a ROM (Read Only Memory) that stores a control program, a working memory such as a RAM (Random Access Memory), and a communication circuit. In this case, functions of the above components are implemented by the CPU executing the control program.

When degradation of taste satisfaction occurs by application of the first modification information to the recipe information, cooking apparatus 100 having such a configuration can apply the first modification information and the second modification information that makes a complement to such degradation of taste satisfaction to the recipe information.

### <Operation of the Cooking Apparatus>

Next, an operation of cooking apparatus 100 will be described with reference to a specific example.

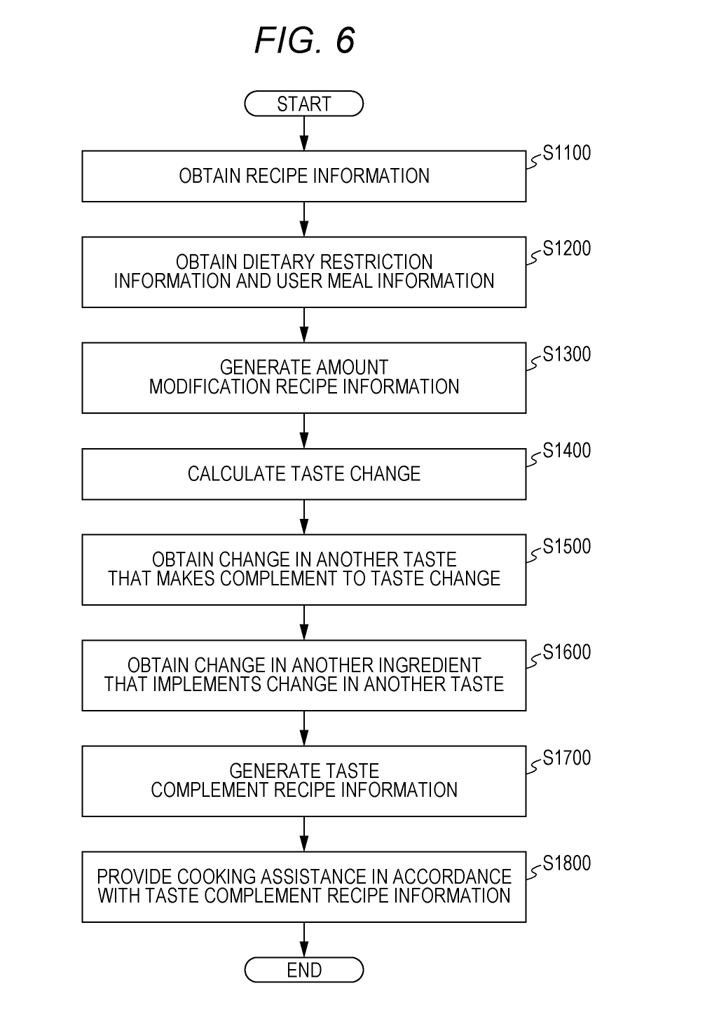

FIG. 6 is a flow chart illustrating an example of an operation of cooking apparatus 100.

First, in step S1100, recipe obtaining unit 110 obtains recipe information.

For example, recipe obtaining unit 110 obtains recipe information for a reference dish that specifies a solid ingredient such as vegetables 450 g, vinegar 20 g, salt 10 g, sugar 10 g, and stock 10 g (500 g in total) as ingredients.

In step S1200, dietary restriction information obtaining unit 121 obtains dietary restriction information. User meal information obtaining unit 122 obtains user meal information.

For example, salt ingestion maximum amount S_{d}=6 g, which is an upper limit of an amount of salt a user may ingest per day, is obtained as the dietary restriction information. In addition, an already ingested salt amount S_{H}=1 g, which is an amount of salt the user has already ingested on that day or during most recent 24 hours, is obtained as the user meal information. When supper is to be prepared, the already ingested salt amount S_{H} is a value obtained by adding salt ingestion amount S_{b} at breakfast and salt ingestion amount Sₗ at lunch, for example.

In step S1300, amount modification recipe generating unit 131 calculates an ingestible amount (information indicating the first modification information) of the first ingredient based on the dietary restriction information and the user meal information, and generates amount modification recipe information (application of the first modification information).

For example, in the above example of the salt ingestion maximum amount S_{d} and the already ingested salt amount S_{H}, amount modification recipe generating unit 131 calculates a salt ingestible amount S_{S}=5 g (S_{d}−S_{H}) as the upper limit of the amount of salt the user may ingest at next meal. Accordingly, amount modification recipe generating unit 131 generates amount modification recipe information that specifies a solid ingredient 450 g, vinegar 20 g, salt 5 g (originally 10 g), sugar 10 g, and stock 10 g as ingredients.

In step S1400, taste change amount obtaining unit 133 calculates taste change, that is, the above difference taste vector.

For example, in the above example of recipe information, if the taste of the solid ingredient is ignored, the taste vector of the reference dish will be “0, 0.14, 0.04, 0.14, 0.16.” In the above example of the amount modification recipe information, the taste vector of the amount modification dish is approximately “0, 0.14, 0.04, 0.09, 0.16.” Accordingly, the difference taste vector will be “0, 0, 0, 0.05, 0.” This difference taste vector indicates that strength of a salty taste has decreased by 0.05 in the amount modification dish compared with the taste of the reference dish.

It should be noted that if change in the amount made by modification of an ingredient is small enough with respect to the entire amount of the reference dish, taste change amount obtaining unit 133 does not necessarily need to calculate the taste vector of the reference dish and the taste vector of the amount modification dish. That is, taste change amount obtaining unit 133 may calculate the difference taste vector by multiplying the ingredient taste vector of the ingredient to be reduced by a ratio of the amount of reduction of the ingredient to the amount of the entire reference dish. In this case, it is not necessarily needed to generate the amount modification recipe information, and amount modification recipe generating unit 131 may not be provided.

In step S1500, complement taste obtaining unit 134 obtains change in another taste (change in a second taste) that makes a complement to taste change (change in a first taste) in the amount modification dish.

For example, in a case of taste complement table 220 illustrated in FIG. 3, degradation of taste satisfaction caused by a salty taste shortage can be complemented by increase in a sour taste or umami taste. It is assumed here that, in taste complement strength information on vinegar, a sour taste of 0.03 corresponds to a salty taste of 0.05, and that in taste complement strength information on stock, an umami taste of 0.1 corresponds to a salty taste of 0.05. Among the ingredients of the reference dish, vinegar includes a sour taste, and stock includes an umami taste. Accordingly, one or both of the sour taste of 0.03 and the umami taste of 0.1 may be obtained as change in the second taste.

It should be noted that complement taste obtaining unit 134 may receive selection from among predetermined first to third policies from the user via the above user interface. Complement taste obtaining unit 134 may then determine the second taste and change in its strength in accordance with the selected policy.

The first policy is a policy of minimizing overall taste change. For example, in a taste radar chart in which a bitter taste axis, a sweet taste axis, an umami taste axis, a salty taste axis, and a sour taste axis are arranged radially, an area of a region of difference between a region that indicates the taste of the reference dish and a region that indicates the taste of a taste complement dish is employed as an evaluation function. Complement taste obtaining unit 134 selects the second taste and change in its strength so that a value of such an evaluation function may become smallest.

The second policy is a policy of minimizing change in taste depth. For example, in the above taste radar chart, a difference between an area of the region that indicates the taste of the reference dish and an area of the region that indicates the taste of the taste complement dish is employed as an evaluation function. Complement taste obtaining unit 134 selects the second taste and change in its strength so that a value of such an evaluation function may become smallest.

The third policy is a policy of minimizing change in a predetermined basic taste. For example, in the above taste radar chart, a difference between strength of the predetermined basic taste in the reference dish and strength of the predetermined basic taste in the taste complement dish is employed as an evaluation function. Complement taste obtaining unit 134 selects the second taste and change in its strength so that a value of such an evaluation function may become smallest.

For example, when an ingestion amount of vinegar is restricted separately, complement taste obtaining unit 134 may determine to change both a sour taste and an umami taste so that both vinegar and stock may be used as complement ingredients.

In step S1600, complement ingredient obtaining unit 135 obtains an amount of change (change in the amount of the second ingredient) in another ingredient that implements change in the above another taste (change in the second taste).

For example, in the above example, since the ingredient of the reference dish includes vinegar, vinegar is determined as the complement ingredient. The ingredient taste vector of vinegar is “0, 1, 0, 1, 4.” An increase of vinegar for increasing a sour taste by 0.03 in the entire modification dish having an amount of 495 g is about 3.7 g. Accordingly, information indicating increasing vinegar by 3.7 g is generated as the complement ingredient information (information indicating the second modification information).

In step S1700, taste complement recipe generating unit 136 then generates taste complement recipe information based on the complement ingredient information (application of the second modification information).

For example, in the above example, vinegar 3.7 g is added to the amount modification recipe information, and the taste complement recipe information is generated that specifies a solid ingredient 450 g, vinegar 23.7 g (originally 20 g), salt 5 g (originally 10 g), sugar 10 g, and stock 10 g as ingredients.

In step S1800, cooking assistance unit 140 provides cooking assistance in accordance with the taste complement recipe information. Accordingly, cooking apparatus 100 ends a series of processing steps.

Such an operation allows cooking apparatus 100 to modify the amount of the second ingredient so that strength of the second taste may change, and to make a complement to degradation of taste satisfaction caused by change in strength of the first taste due to modification of the amount of the first ingredient.

### <Effect of the Present Exemplary Embodiment>

As described above, when application of the first modification information to the recipe information causes degradation of taste satisfaction, cooking apparatus 100 according to the present exemplary embodiment can apply the first modification information and second modification information that makes a complement to such degradation of taste satisfaction to the recipe information. This allows cooking apparatus 100 according to the present exemplary embodiment to minimize degradation of taste satisfaction caused by modification of the recipe information.

In addition, cooking apparatus 100 according to the present exemplary embodiment determines the second modification information by using the taste complement table and taste complement strength information that indicate a complement relationship between the first taste and the second taste. This allows cooking apparatus 100 according to the present exemplary embodiment to reduce processing loads and an amount of information to be stored through preparation of a table for each of five taste combinations instead of a table for each of combinations of an enormous number of ingredients.

### <Variation of the Present Exemplary Embodiment>

Part of units of cooking apparatus 100, such as information storing unit 132, may be disposed separately from other units on a server on a communication network, for example.

Recipe obtaining unit 110 may generate recipe information by modifying an amount of at least one of a plurality of ingredients that includes the obtained original recipe information based on the original recipe information for a dish, preference information of a user, and obtained preference information.

The first ingredient, the first taste, the second ingredient, and the second taste are not limited to the above examples. For example, when carbohydrates are to be reduced in cooking of simmered dishes, the first ingredient is sugar, and the first taste is a sweet taste. It is known that degradation of taste satisfaction caused by reduction in a sweet taste can be complemented through increase in an umami taste. Accordingly, the second taste is an umami taste, and granule stock can be selected as the second ingredient that is a complement ingredient. An ingredient that is not described in recipe information can also be added.

Forms and content of the ingredient taste table, taste complement table, and taste complement strength information are not limited to the above examples. For example, cooking apparatus 100 may previously store a table that integrates the taste complement table and the taste complement strength information, and may determine a complement ingredient and its amount with reference to such a table. Alternatively, cooking apparatus 100 may store a table that directly associates the amount of the first ingredient, and the second ingredient and its amount that make a complement to degradation of taste satisfaction caused by such reduction of the amount of the first ingredient. Cooking apparatus 100 may then determine the complement ingredient and its amount with reference to such a table.

Cooking apparatus 100 may increase the first ingredient and generate amount modification recipe information. Cooking apparatus 100 may make a complement to degradation of taste satisfaction by increasing the second ingredient. Furthermore, cooking apparatus 100 may add an ingredient that is not included in the recipe information as a complement ingredient to generate the taste complement recipe information.

Each of the first taste and the second taste may be a taste produced through combination of the plurality of basic tastes.

The first modification information and the second modification information may be change in other cooking methods, such as change in cooking time, instead of change in an amount of an ingredient.

### Second Exemplary Embodiment

A second exemplary embodiment of the present disclosure will be described in detail below with reference to the drawings. In a similar manner to the first exemplary embodiment, a cooking apparatus according to the present exemplary embodiment is, for example, a microwave oven, an IH (Induction Heating) cooking heater, or an apparatus in which these functions cooperate, including a user interface such as a touch-panel display.

### <Configuration of the Cooking Apparatus>

First, a configuration of the cooking apparatus according to the present exemplary embodiment will be described.

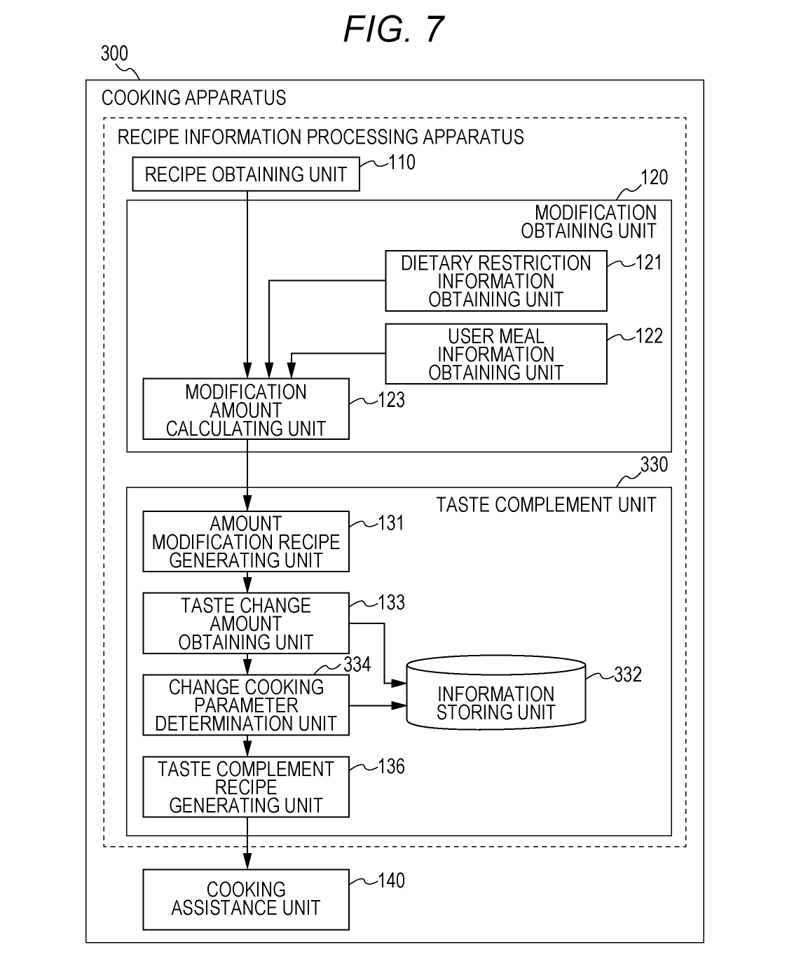

FIG. 7 is a block diagram illustrating an example of a configuration of the cooking apparatus according to the present exemplary embodiment.

In FIG. 7, cooking apparatus 300 includes recipe obtaining unit 110, modification obtaining unit 120, taste complement unit 330, and cooking assistance unit 140. It should be noted that recipe obtaining unit 110 to taste complement unit 130 correspond to a recipe information processing apparatus according to the present exemplary embodiment.

In a similar manner to the first exemplary embodiment, recipe obtaining unit 110 obtains recipe information for a dish, and outputs the obtained recipe information to modification obtaining unit 120.

In a similar manner to the first exemplary embodiment, modification obtaining unit 120 includes dietary restriction information obtaining unit 121, user meal information obtaining unit 122, and modification amount calculating unit 123. Modification obtaining unit 120 outputs the recipe information and an ingestible amount (information indicating first modification information) to taste complement unit 330.

Taste complement unit 330 generates taste complement recipe information by applying to the recipe information the first modification information and second modification information that makes a complement to degradation of taste satisfaction caused by application of the first modification information to the recipe information.

In the present exemplary embodiment, the first modification information shall be modification of an amount of a first ingredient (for example, salt), and the second modification information shall be modification of heating time. Modification of the heating time produces change in strength of a first taste (for example, a salty taste) that makes a complement to degradation of taste satisfaction caused by change in the strength of the first taste due to modification of the amount of the first ingredient.

Taste complement unit 330 includes amount modification recipe generating unit 131, information storing unit 332, taste change amount obtaining unit 133, change cooking parameter determination unit 334, and taste complement recipe generating unit 136.

Amount modification recipe generating unit 131 makes a modification (first modification information) to the recipe information that is input from modification obtaining unit 120 so that the amount of the first ingredient may be equal to or less than the ingestible amount that is input from modification obtaining unit 120, to generate amount modification recipe information. Amount modification recipe generating unit 131 then outputs the recipe information and the generated amount modification recipe information to taste change amount obtaining unit 133.

Information storing unit 332 previous y stores information required for processing performed by taste change amount obtaining unit 133 and change cooking parameter determination unit 334. More specifically, information storing unit 332 stores an ingredient taste table, a taste change table, and taste change information.

In a similar manner to the first exemplary embodiment, the ingredient taste table is a table that describes a relationship between change in an amount of each of a plurality of ingredients including the first ingredient and change in taste strength caused by the change in the amount of the ingredient.

The taste change table is a table that describes a relationship between a cooking parameter and a taste having strength changed by changing the cooking parameter in each food ingredient.

The taste change information corresponds to a diagram illustrating a relationship between change in the heating time and change in strength of the first taste.

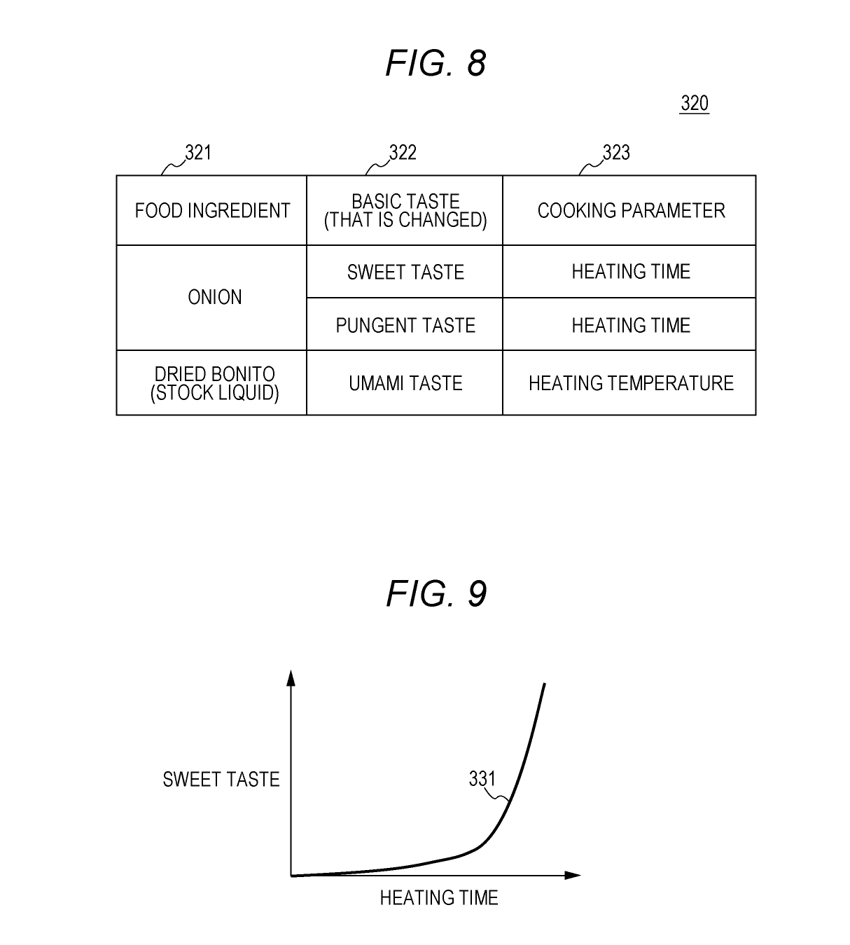

FIG. 8 is a diagram illustrating an example of the taste change table.

As illustrated in FIG. 8, for each food ingredient 321, taste change table 320 associates basic taste 322 that is changed by the cooking parameter among basic tastes of the food ingredient with cooking parameter 323 that causes the change, and describes basic taste 322 that is changed and cooking parameter 323.

For example, basic taste 322 of “a sweet taste” and “a pungent taste” are described for food ingredient 321 of an onion. In addition, “heating time” is described in relation to “a sweet taste”, and “heating time” is described in relation to “a pungent taste” as cooking parameter 323. This means that change in the heating time, which is a cooking parameter, causes change in strength of a sweet taste and a pungent taste.

Actually, prolonged heating time of an onion changes a heated component within the onion into a sweet component. Therefore, prolonged heating time enhances a sweet taste and decreases a pungent taste.

FIG. 9 is a diagram illustrating an example of taste change information. In FIG. 9, a horizontal axis represents heating time, and a vertical axis represents strength of change in the basic taste in a dish.

As illustrated by line 331 of FIG. 9, change in a length of heating time has a relationship with change in strength of a sweet taste. That is, the length of heating time and the strength of a sweet taste have a relationship that makes a mutual complement to degradation of taste satisfaction caused by degradation in a sweet taste.

The taste change information differs, for example, according to a dish type or an ingredient type that is to be increased and decreased. FIG. 9 shows the taste change information that illustrates a correlation between the heating time of an onion and change in a sweet taste. An influence degree (influence degree on magnitude of a taste vector of a dish) of a sweet taste of an onion on a dish differs between a case where the dish is onion gratin soup and a case where the dish is curry, and thus how a curved line bends differs.

In this way, when the taste change information differs according to the dish type, information storing unit 332 may store the taste change information for each dish type.

Reasons for degradation of taste satisfaction include various reasons such as a weaker taste as a whole and change in taste balance, other than just weaker main basic taste of the reduced food ingredient. In addition, principles of inhibition of degradation in taste satisfaction are diverse as described above. Accordingly, for example, based on a result of an experiment or empirical rules, appropriate taste change information is prepared and stored.

In a similar manner to the first exemplary embodiment, with reference to ingredient taste table 210 (see FIG. 2), taste change amount obtaining unit 133 of FIG. 7 calculates, from the recipe information that is input from amount modification recipe generating unit 131, the taste vector of the dish (reference dish) that is cooked in accordance with the recipe information. In addition, with reference to ingredient taste table 210, taste change amount obtaining unit 133 calculates, from the amount modification recipe information that is input from amount modification recipe generating unit 131, the taste vector of the dish (hereinafter referred to as an “amount modification dish”) that is cooked in accordance with the amount modification recipe information.

Each component of the taste vector is an amount proportional to a value obtained by adding a correction number unique to each basic taste to a logarithm of concentration of the basic taste, in a similar manner to the first exemplary embodiment.

Furthermore, taste change amount obtaining unit 133 calculates a vector by subtracting the taste vector of the amount modification dish from the taste vector of the reference dish as a difference taste vector, in a similar manner to the first exemplary embodiment. Taste change amount obtaining unit 133 then outputs the amount modification recipe information and the calculated difference taste vector to change cooking parameter determination unit 334.

With reference to taste change table 320 and the taste change information (see FIG. 9), change cooking parameter determination unit 334 determines change in the cooking parameter (“heating time” here) to make a complement to degradation of taste satisfaction from the difference taste vector that is input from taste change amount obtaining unit 133.

More specifically, change cooking parameter determination unit 334 determines a pair of food ingredient and cooking parameter that can make a complement to change in strength of the first taste indicated by the difference taste vector based on taste change table 320. Change cooking parameter determination unit 334 then obtains degree of change in the cooking parameter of the food ingredient corresponding in degree of change in strength of the first taste indicated by the difference taste vector from the taste change information. Change cooking parameter determination unit 334 then outputs the amount modification recipe information and the cooking parameter to be changed and a value of the changed cooking parameter (change cooking parameter information) to taste complement recipe generating unit 136.

Taste complement recipe generating unit 136 modifies the amount modification recipe information that is input from change cooking parameter determination unit 334 into information (second modification information) that has a heating time extended in accordance with the change cooking parameter information that is input from change cooking parameter determination unit 334. Taste complement recipe generating unit 136 then generates the taste complement recipe information. Taste complement recipe generating unit 136 then outputs the generated taste complement recipe information to cooking assistance unit 140.

Cooking assistance unit 140 assists cooking in accordance with the taste complement recipe information that is input from taste complement recipe generating unit 136, in a similar manner to the first exemplary embodiment.

It should be noted that cooking assistance unit 140 may use speech recognition or gesture recognition as the user interface in addition to the touch panel, in a similar manner to the first exemplary embodiment. In addition, when part of functions of cooking apparatus 100 is on a cloud, cooking assistance unit 140 may not include a display device, and may use, for example, a display of a smart phone and a smart television that operate in cooperation with functions of cooking apparatus 100.

Although not illustrated, cooking apparatus 300 includes, for example, a CPU (Central Processing Unit), a storage medium such as a ROM (Read Only Memory) that stores a control program, a working memory such as a RAM (Random Access Memory), and a communication circuit, in a similar manner to the first exemplary embodiment. In this case, functions of the above components are implemented by the CPU executing the control program.

When degradation of taste satisfaction occurs by application of the first modification information to the recipe information, cooking apparatus 300 having such a configuration can apply the first modification information and the second modification information that makes a complement to such degradation of taste satisfaction to the recipe information.

### <Operation of the Cooking Apparatus>

Next, an operation of cooking apparatus 300 will be described with reference to a specific example.

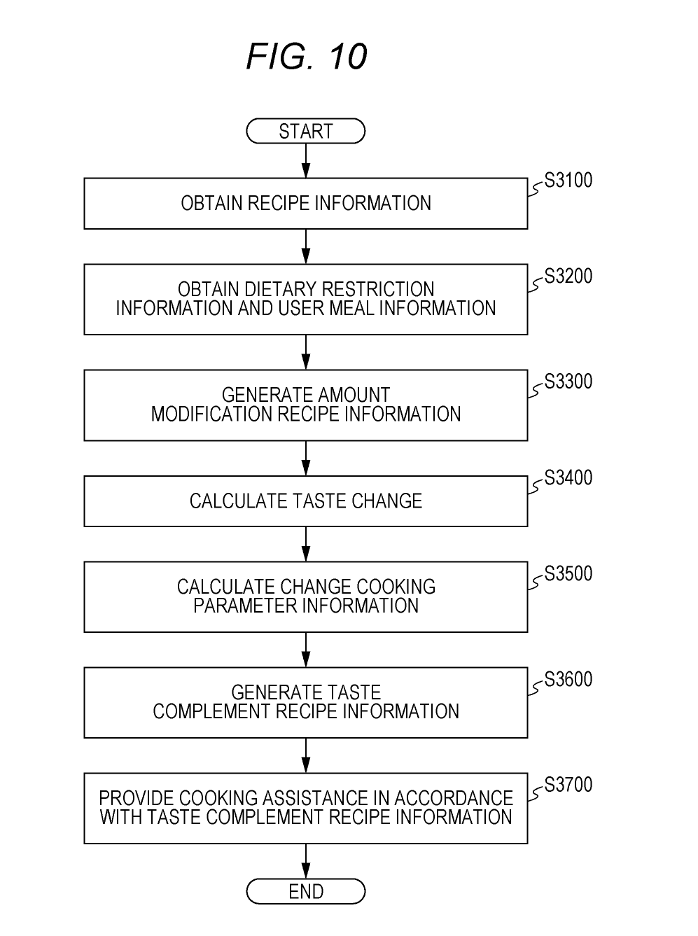

FIG. 10 is a flow chart illustrating an example of an operation of cooking apparatus 300.

First, in step S3100, recipe obtaining unit 110 obtains recipe information. For example, recipe obtaining unit 110 obtains recipe information for a reference dish that specifies a solid ingredient such as vegetables 450 g, salt 5 g, sugar 50 g, and consommé 10 g as ingredients.

In step S3200, dietary restriction information obtaining unit 121 obtains dietary restriction information. User meal information obtaining unit 122 obtains user meal information.

For example, carbohydrate ingestion maximum amount C_{d}=120 g, which is an upper limit of an amount of carbohydrate a user may ingest per day, is obtained as the dietary restriction information. In addition, an already ingested carbohydrate amount C_{H}=90 g, which is an amount of carbohydrate the user has already ingested on that day or during most recent 24 hours, is obtained as the user meal information. When supper is to be prepared, the already ingested carbohydrate amount C_{H} is a value obtained by adding carbohydrate ingestion amount C_{b} at breakfast and carbohydrate ingestion amount Cₗ at lunch, for example.

In step S3300, amount modification recipe generating unit 131 calculates an ingestible amount (information indicating the first modification information) of the first ingredient based on the dietary restriction information and the user meal information, and generates amount modification recipe information (application of the first modification information).

For example, in the above example of the carbohydrate ingestion maximum amount C_{d} and the already ingested carbohydrate amount C_{H}, amount modification recipe generating unit 131 calculates a carbohydrate ingestible amount C_{S}=30 g (C_{d}−C_{H}) (in terms of sugar) as the upper limit of the amount of carbohydrate the user may ingest at next meal. Accordingly, amount modification recipe generating unit 131 generates amount modification recipe information that specifies a solid ingredient 450 g, salt 5 g, sugar 30 g, and consommé 10 g as ingredients.

In step S3400, taste change amount obtaining unit 133 calculates taste change, that is, the above difference taste vector.

For example, in the above example of recipe information, if the taste of the solid ingredient is ignored, the taste vector of the reference dish will be “0, 0.14, 0.04, 0.14, 0.16.” In the above example of the amount modification recipe information, the taste vector of the amount modification dish is approximately “0, 0.09, 0.04, 0.14, 0.16.” Accordingly, the difference taste vector will be “0, 0.05, 0, 0, 0.” This difference taste vector indicates that strength of a sweet taste has decreased by 0.05 in the amount modification dish compared with the taste of the reference dish.

In step S3500, change cooking parameter determination unit 334 calculates and outputs the change cooking parameter information to taste complement recipe generating unit 136.

For example, in a case of taste change table 320 illustrated in FIG. 9, degradation of taste satisfaction caused by a sweet taste shortage can be complemented by change in heating time of an onion. It is assumed here that, in the taste change information, enhancing a sweet taste by 0.05 corresponds to extension of heating time by five minutes. Accordingly, change cooking parameter information is set to extend the heating time in heating sequence of an onion in a cooking recipe for 5 minutes.

It should be noted that change cooking parameter determination unit 334 may receive selection from among predetermined first to third policies from the user via the above user interface. Change cooking parameter determination unit 334 may then determine the food ingredient and change in the cooking parameter in accordance with the selected policy.

The first policy is a policy of minimizing overall taste change. For example, in a taste radar chart in which a bitter taste axis, a sweet taste axis, an umami taste axis, a salty taste axis, and a sour taste axis are arranged radially, an area of a region of difference between a region that indicates the taste of the reference dish and a region that indicates the taste of a taste complement dish is employed as an evaluation function. Change cooking parameter determination unit 334 selects the food ingredient and change in the cooking parameter so that a value of such an evaluation function may become smallest.

The second policy is a policy of minimizing change in taste depth. For example, in the above taste radar chart, a difference between an area of the region that indicates the taste of the reference dish and an area of the region that indicates the taste of the taste complement dish is employed as an evaluation function. Change cooking parameter determination unit 334 selects the food ingredient and change in the cooking parameter so that a value of such an evaluation function may become smallest.

The third policy is a policy of minimizing change in the predetermined basic taste. For example, in the above taste radar chart, a difference between strength of the predetermined basic taste in the reference dish and strength of the predetermined basic taste in the taste complement dish is employed as an evaluation function. Change cooking parameter determination unit 334 selects the food ingredient and change in the cooking parameter so that a value of such an evaluation function may become smallest.

In step S3600, taste complement recipe generating unit 136 generates the taste complement recipe information based on the change cooking parameter information (application of the second modification information).

For example, in the above example, taste complement recipe information that specifies heating time in heating sequence of an onion as 5 minutes is generated.

In step S3700, cooking assistance unit 140 provides cooking assistance in accordance with the taste complement recipe information. For example, when specified that heating time is five minutes, electric power may be applied to an IH coil or a magnetron for continuous five-minute heating. Accordingly, cooking apparatus 300 ends a series of processing steps.

Such an operation allows cooking apparatus 300 to modify the cooking parameter so that strength of the first taste may change, and to make a complement to degradation of taste satisfaction caused by change in strength of the first taste due to modification of the amount of the first ingredient.

### <Effect of the Present Exemplary Embodiment>

As described above, when application of the first modification information to the recipe information causes degradation of taste satisfaction, cooking apparatus 300 according to the present exemplary embodiment can apply the first modification information and second modification information that makes a complement to such degradation of taste satisfaction to the recipe information. This allows cooking apparatus 300 according to the present exemplary embodiment to minimize degradation of taste satisfaction caused by modification of the recipe information.

### <Variation of the Present Exemplary Embodiment>

Part of units of cooking apparatus 300, such as information storing unit 332, may be disposed separately from other units on a server on a communication network, for example.

Recipe obtaining unit 110 may generate recipe information by modifying an amount of at least one of a plurality of ingredients that includes the obtained original recipe information based on the original recipe information for a dish, preference information of a user, and obtained preference information.

Although heating time is described as the cooking parameter that causes change in the basic taste, the cooking parameter is not limited to heating time. As the cooking parameter to be modified, various parameters that affect a state of a dish can be employed, such as, for example, pressure, cooking time, output settings of a microwave oven, heating temperature, cooling temperature, amount of steam, stirring state, crushing state, kneading state, fermentation degree, and component change degree.

In addition, a plurality of cooking parameters that causes change in the basic taste may be used. For example, it may be taken into consideration that a sweet taste of a food ingredient is changed by both heating time and heating temperature.

In addition to change in the cooking parameter disclosed in the present second exemplary embodiment, degradation of taste satisfaction may be complemented by modification of the amount of the ingredient disclosed in the first exemplary embodiment.

### <Summary of the Present Disclosure>

A recipe information processing apparatus according to the present disclosure includes: a recipe obtaining unit that obtains recipe information for a dish; a modification obtaining unit that obtains first modification information used to modify the obtained recipe information; and a taste complement unit that generates taste complement recipe information based on the obtained recipe information, the first modification information, and second modification information, the second modification information making a complement to degradation of taste satisfaction with a dish offered based on the obtained recipe information modified by using the first modification information.

In the recipe information processing apparatus, the first modification information may be related to modification of an amount of a first ingredient, and the second modification information may be related to modification of an amount of a second ingredient.

In the recipe information processing apparatus, the degradation of the taste satisfaction may be caused by change in strength of a first taste due to the modification of the amount of the first ingredient, and the modification of the amount of the second ingredient may produce change in strength of a second taste that makes a complement to the degradation of the taste satisfaction.

In the recipe information processing apparatus, the taste complement unit may include: an amount modification recipe generating unit that generates amount modification recipe information by making the modification of the amount of the first ingredient to the recipe information; a taste change amount obtaining unit that obtains the change in the strength of the first taste corresponding to the modification of the amount of the first ingredient with reference to an ingredient taste table including a plurality of relationships including a first relationship related to the first ingredient and a second relationship related to the second ingredient, each of the plurality of relationships indicating a relationship between change in an amount of an ingredient and change in strength of a plurality of tastes caused by the change in the amount of the ingredient; a complement taste obtaining unit that obtains the change in the strength of the second taste corresponding to the change in the strength of the first taste, with reference to a taste complement strength table that describes a relationship between the change in the strength of the first taste and the change in the strength of the second taste that makes a complement to the degradation of the taste satisfaction caused by the change in the strength of the first taste; a complement ingredient obtaining unit that obtains change in the amount of the second ingredient corresponding to the change in the strength of the second taste with reference to the ingredient taste table; and a taste complement recipe generating unit that generates the taste complement recipe information by applying the change in the amount of the second ingredient to the amount modification recipe information.

In the recipe information processing apparatus, the complement taste obtaining unit may obtain the change in the strength of the second taste in accordance with at least one of a first policy of minimizing overall change in a taste, a second policy of minimizing change in depth of a taste, and a third policy of minimizing change in a predetermined basic taste.

In the recipe information processing apparatus, the modification obtaining unit may obtain a period maximum amount that is an upper limit of the amount of the first ingredient a user may ingest during a predetermined period, and an already ingested amount that is the amount of the first ingredient the user has already ingested during the predetermined period, and may define modification to make the amount of the first ingredient equal to or less than a value obtained by subtracting the already ingested amount from the period maximum amount as the first modification information.

In the recipe information processing apparatus, the first modification information may be modification of an amount of a first ingredient, and the second modification information may be modification of a cooking parameter of a second ingredient.

In the recipe information processing apparatus, the modification of the cooking parameter may be modification of cooking time of an ingredient.

In the recipe information processing apparatus, the modification of the cooking parameter may be modification of cooking temperature of an ingredient.

In the recipe information processing apparatus, the modification of the cooking parameter may be modification of cooking pressure to be applied on an ingredient.

A cooking apparatus according to the present disclosure includes: a recipe obtaining unit that obtains recipe information for a dish; a modification obtaining unit that obtains first modification information to be applied to the obtained recipe information; a taste complement unit that generates taste complement recipe information based on the obtained recipe information, the first modification information, and second modification information, the second modification information making a complement to degradation of taste satisfaction caused by application of the first modification information to the recipe information; and a cooking assistance unit that assists cooking in accordance with the taste complement recipe information.

In the cooking apparatus, the cooking assistance unit may include a heater, and the heater may apply electric power to the heater in accordance with the taste complement recipe information.

A method for processing recipe information according to the present disclosure involves: obtaining recipe information for a dish; obtaining first modification information used to modify the obtained recipe information; and generating taste complement recipe information based on the obtained recipe information, the first modification information, and second modification information, the second modification information making a complement to degradation of taste satisfaction with a dish offered based on the obtained recipe information modified by using the first modification information.

The present disclosure is useful as a recipe information processing apparatus, a cooking apparatus, and a method for processing recipe information capable of minimizing degradation of taste satisfaction accompanying modification of recipe information.

What is claimed is:

1. A recipe information processing apparatus comprising:
a recipe obtaining unit that obtains recipe information for a dish;
a modification obtaining unit that obtains first modification information used to modify the obtained recipe information; and
a taste complement unit that generates taste complement recipe information based on the obtained recipe information, the first modification information, and second modification information, the second modification information making a complement to degradation of taste satisfaction with a dish offered based on the obtained recipe information modified by using the first modification information.

2. The recipe information processing apparatus according to claim 1, wherein
the first modification information is related to modification of an amount of a first ingredient, and
the second modification information is related to modification of an amount of a second ingredient.

3. The recipe information processing apparatus according to claim 2, wherein
the degradation of the taste satisfaction is caused by change in strength of a first taste due to the modification of the amount of the first ingredient, and
the modification of the amount of the second ingredient produces change in strength of a second taste that makes a complement to the degradation of the taste satisfaction.

4. The recipe information processing apparatus according to claim 3, wherein the taste complement unit comprises:
an amount modification recipe generating unit that generates amount modification recipe information by making the modification of the amount of the first ingredient to the recipe information;
a taste change amount obtaining unit that obtains the change in the strength of the first taste corresponding to the modification of the amount of the first ingredient with reference to an ingredient taste table including a plurality of relationships including a first relationship related to the first ingredient and a second relationship related to the second ingredient, each of the plurality of relationships indicating a relationship between change in an amount of an ingredient and change in strength of a plurality of tastes caused by the change in the amount of the ingredient;
a complement taste obtaining unit that obtains the change in the strength of the second taste corresponding to the change in the strength of the first taste, with reference to a taste complement strength table that describes a relationship between the change in the strength of the first taste and the change in the strength of the second taste that makes a complement to the degradation of the taste satisfaction caused by the change in the strength of the first taste;
a complement ingredient obtaining unit that obtains change in the amount of the second ingredient corresponding to the change in the strength of the second taste with reference to the ingredient taste table; and
a taste complement recipe generating unit that generates the taste complement recipe information by applying the change in the amount of the second ingredient to the amount modification recipe information.

5. The recipe information processing apparatus according to claim 4, wherein the complement taste obtaining unit obtains the change in the strength of the second taste in accordance with at least one of a first policy of minimizing overall change in a taste, a second policy of minimizing change in depth of a taste, and a third policy of minimizing change in a predetermined basic taste.

6. The recipe information processing apparatus according to claim 2, wherein the modification obtaining unit:
obtains a period maximum amount that is an upper limit of the amount of the first ingredient a user may ingest during a predetermined period, and an already ingested amount that is the amount of the first ingredient the user has already ingested during the predetermined period, and
defines modification to make the amount of the first ingredient equal to or less than a value obtained by subtracting the already ingested amount from the period maximum amount as the first modification information.

7. The recipe information processing apparatus according to claim 1, wherein
the first modification information is modification of an amount of a first ingredient, and
the second modification information is modification of a cooking parameter of a second ingredient.

8. The recipe information processing apparatus according to claim 7, wherein the modification of the cooking parameter is modification of cooking time of an ingredient.

9. The recipe information processing apparatus according to claim 7, wherein the modification of the cooking parameter is modification of cooking temperature of an ingredient.

10. The recipe information processing apparatus according to claim 7, wherein the modification of the cooking parameter is modification of cooking pressure to be applied on an ingredient.

11. A cooking apparatus comprising:
a recipe obtaining unit that obtains recipe information for a dish;
a modification obtaining unit that obtains first modification information to be applied to the obtained recipe information;
a taste complement unit that generates taste complement recipe information based on the obtained recipe information, the first modification information, and second modification information, the second modification information making a complement to degradation of taste satisfaction caused by application of the first modification information to the recipe information; and
a cooking assistance unit that assists cooking in accordance with the taste complement recipe information.

12. The cooking apparatus according to claim 11, wherein
the cooking assistance unit comprises a heater, and
the heater applies electric power to the heater in accordance with the taste complement recipe information.

13. A method for processing recipe information comprising:
obtaining recipe information for a dish;
obtaining first modification information used to modify the obtained recipe information; and
generating taste complement recipe information based on the obtained recipe information, the first modification information, and second modification information, the second modification information making a complement to degradation of taste satisfaction with a dish offered based on the obtained recipe information modified by using the first modification information.
